(19) United States
(12) Patent Application Publication
(10) Pub. No.: US 2025/0055881 A1
(43) Pub. Date: Feb. 13, 2025

(54) MONITORING AND CORRECTING CONFIGURATION AND CONFIGURATION DRIFT IN CLOUD ACCOUNTS

(71) Applicant: VMWARE LLC, Palo Alto, CA (US)

(72) Inventors: SUMIT SURESH KEDIA, Pune (IN); PRANALI PRAVIN LOKARE, Pune (IN); ASHITOSH DILIP WAGH, Pune (IN); MANOJ KUMAR JAIN, Pune (IN); PRIYANKA RAJESH MALODE, Nasik (IN)

(21) Appl. No.: 18/378,678

(22) Filed: Oct. 11, 2023

(30) Foreign Application Priority Data
Aug. 8, 2023 (IN) 202341053244

(51) Int. Cl. H04L 9/40

(52) U.S. Cl. CPC H04L 63/20; H04L 63/102; H04L 63/108

(57) ABSTRACT

Systems, apparatus, articles of manufacture, and methods are disclosed that monitor and correct for configuration drift in cloud accounts by instantiating or executing machine-readable instructions to access target state configuration information from a first user account for a cloud account, onboard the cloud account at a first time to configure cloud resources based on the target state configuration information, detect a first drift between the target state configuration information and an in-use configuration state of the cloud account at a second time, log a corresponding change in the in-use configuration state relative to the target state configuration information, the first event record logged in a timeline of second event records representing second drifts of the cloud account relative to the target state configuration information, and after the detection of the first drift, change an in-use configuration of the cloud account based on the target state configuration information.

### RELATED APPLICATIONS

Benefit is claimed under 35 U.S.C. 119(a)-(d) to Foreign application Serial No. 202341053244 filed in India entitled “MONITORING AND CORRECTING CONFIGURATION AND CONFIGURATION DRIFT IN CLOUD ACCOUNTS”, on Aug. 8, 2023, by VMware, Inc., which is herein incorporated in its entirety by reference for all purposes.

### FIELD OF THE DISCLOSURE

This disclosure relates generally to cloud infrastructure and, more particularly, to monitoring and correcting configuration and configuration drift in cloud accounts.

### BACKGROUND

In recent years, cloud computing infrastructure is accessible by multiple users. The multiple users may access any of a plurality of public clouds. Some example public clouds include Amazon Web Services®, Google Cloud Platform™, and Microsoft Azure®.

### BRIEF DESCRIPTION OF THE DRAWINGS

FIG. 1 is a schematic block diagram of an example environment in which example cloud account manager that operates to monitor and correct configuration drift in cloud accounts can be implemented.

FIG. 2 is a block diagram of an example implementation of the cloud account manager of FIG. 1.

FIG. 3 is an example execution architecture environment of the example cloud account manager of FIG. 1.

FIG. 4 is an example sequence diagram of the example cloud account manager of FIG. 1.

FIG. 5 is an illustration of onboarding a user account.

FIGS. 6-7 are flowcharts representatives of example machine readable instructions and/or example operations that may be executed, instantiated, and/or performed by example programmable circuitry to implement the cloud account manager of FIG. 2.

FIG. 8 is a block diagram of an example processing platform including programmable circuitry structured to execute, instantiate, and/or perform the example machine readable instructions and/or perform the example operations of FIGS. 6-7 to implement the cloud account manager of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 6-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

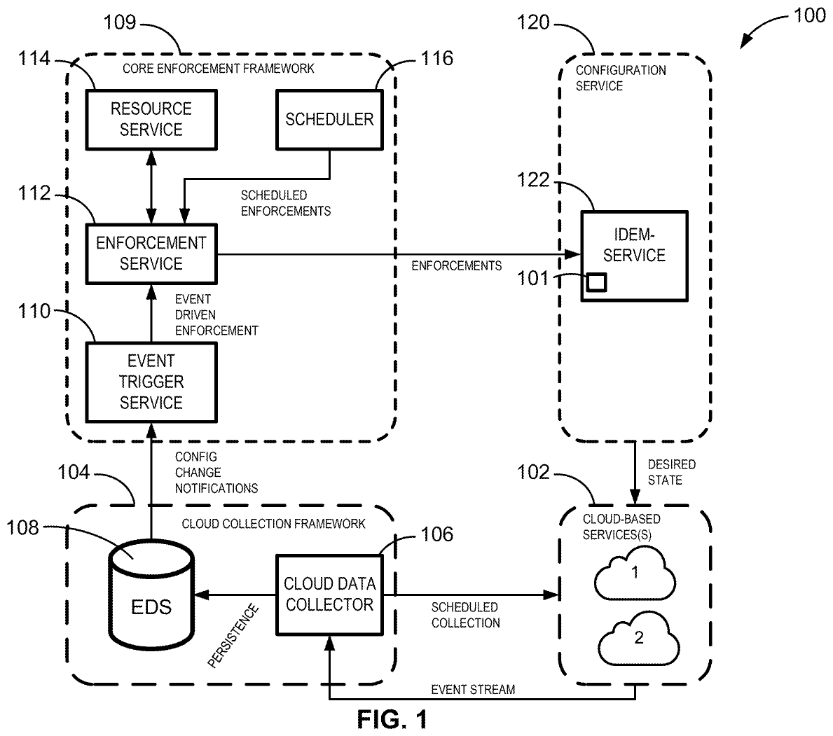

FIG. 1 is a schematic block diagram of an example environment 100 in which an example cloud account manager 101 that operates to manage deployment of microservices of a distributed computing system can be implemented. In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1 is only an example and any appropriate other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 can extract, receive and/or query information (e.g., components, metadata, services, service information) from the cloud-based service(s) 102. In this example, the cloud data collector 106 can request and/or direct the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110, an example enforcement service 112 that implements the aforementioned cloud account manager 101, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service 122 that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation/provisioning engine that implements desired state changes with respect to the cloud-based service(s) 102 based on target state configuration information. In other words, the IDEM service 122 controls a desired state of the cloud-based service(s) 102 based on enforcements provided from the enforcement service 112 in the form of target state configuration information. In some examples, the IDEM service 122 implements target state configuration information and controls the target state configuration information of the cloud-based service(s) 102 based on enforcements provided from the enforcement service 112. While the cloud account manager 101 is shown implemented in the example IDEM service 122, additionally or alternatively, the cloud account manager 101 can be implemented in the event trigger service 110, the enforcement service 112, the resource service 114 and/or the scheduler 116.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services, examples disclosed herein can be implemented in conjunction with any appropriate distributed and/or shared computing resource system.

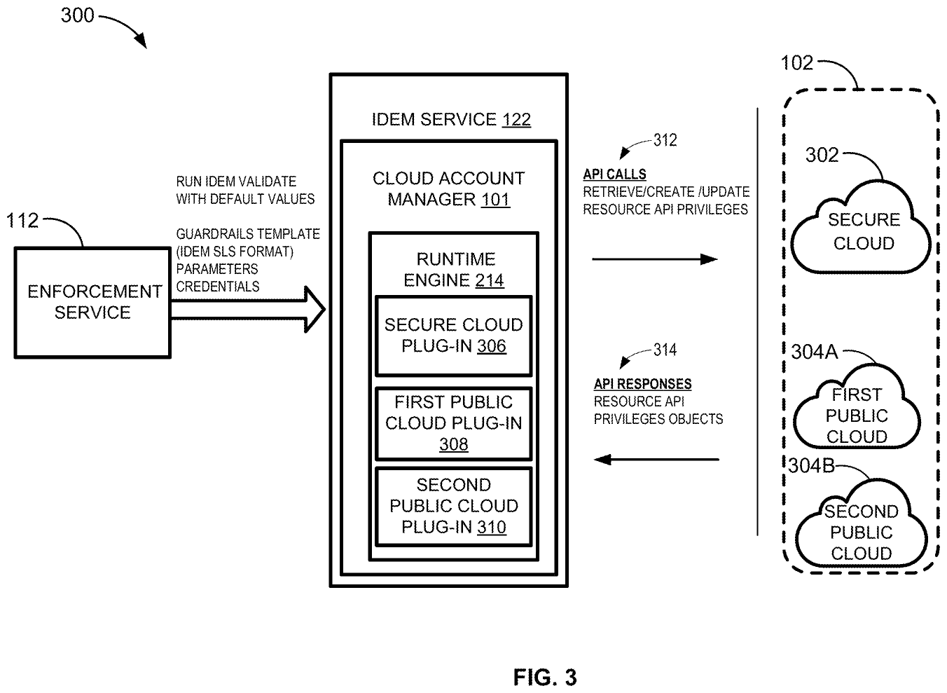

Users of the cloud computing infrastructure may experience difficulty in onboarding new user accounts. In some examples, the users of the cloud computing infrastructure are unable to complete actions in a secure cloud (FIG. 3), as the secure cloud requires user interaction. In some examples, a secure cloud may be implemented by Secure Cloud™, Aria Hub™, or CLOUDHEALTH®. The onboarding process is a first operation in an Infrastructure-As-Code (IAC) process. A difficult onboarding process corresponds to a poor user experience of using the cloud computing infrastructure.

User onboarding is a process which typically includes errors and is not seamless. Typically, a user will perform multiple actions for each account that is to be onboarded. As such, the user onboarding process is time consuming, error-prone, repetitive, difficult to protect from unwanted changes, and requires an understanding of cloud infrastructure. The user onboarding process is time consuming, as Amazon Web Services (AWS) configuration (CFN) requires time to process the user driven actions. The user onboarding process is error-prone, as a human user of the cloud account may make a mistake based on a typing slip or a misjudged decision. The user onboarding process requires an understanding of running executables which may require a learning curve of AWS command line interface (CLI) and AWS Profile. The learning curve is to understand how to configure valid credentials and permissions for AWS Profile.

The user onboarding process is repetitive as the user onboarding process is to be executed whenever a new account is onboarded. Additionally, the user onboarding process is to be executed by the user, whenever a cloud health team updates new policies. In some examples, after the cloud health team updates a policy, the change is to be applied to all the existing cloud accounts that were onboarded through Cloud Health, and the user is to onboard each of these existing cloud accounts individually. In some examples, after a security key rotation occurs, the user onboarding process is to be completed again. In such examples, a security key rotation may occur on a periodic basis (e.g., once a month, every ninety days, etc.). In these examples, the first security key expires after the period of time has elapsed, and a second security key is needed.

The user onboarding process lacks governance. At present, the user onboarding process does not include a mechanism for protecting the onboarded accounts and the related cloud infrastructure resources associated with the onboarded accounts from external user operations (e.g., update, delete, modify, etc.). In some examples, if an onboarded account is changed, then there may be a service disruption.

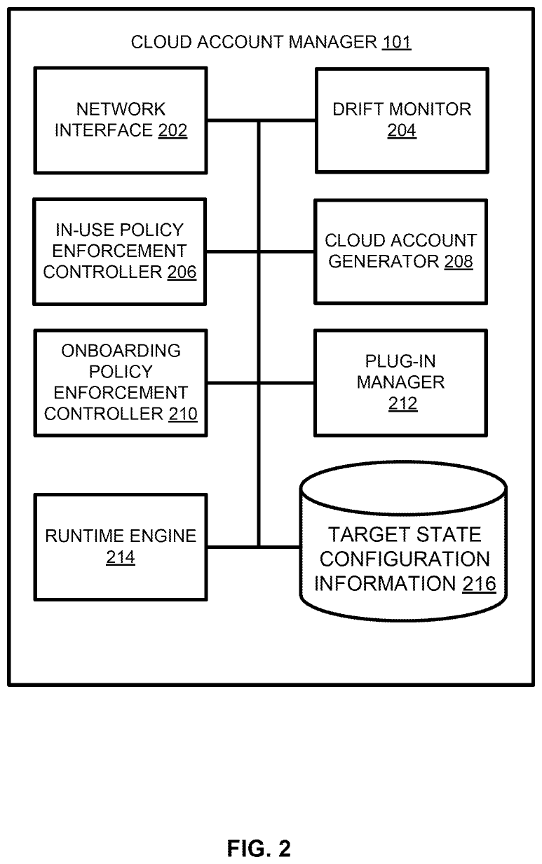

FIG. 2 is a block diagram of an example implementation of the cloud account manager 101 of FIG. 1 to monitor and correct for configuration drift in cloud accounts. The example cloud account manager 101 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the example cloud account manager 101 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example cloud account manager 101 includes an example network interface 202, an example drift monitor 204, an example in-use policy enforcement controller 206, an example cloud account generator 208, an example onboarding policy enforcement controller 210, an example plug-in manager 212, an example runtime engine 214, and an example target state configuration information database 216. In some examples, the network interface 202, the drift monitor 204, the in-use policy enforcement controller 206, the cloud account generator 208, the onboarding policy enforcement controller 210, the plug-in manager 212, and the runtime engine 214 are implemented as circuitry (e.g., drift monitor circuitry, continuous enforcement controller circuitry, cloud account generator circuitry, policy enforcement controller circuitry, plug-in manager circuitry, and runtime engine circuitry). The example cloud account manager 101 is to simplify cloud account onboarding and off-boarding by using templates. The example cloud account manager 101 is to use custom plug-ins that support Secure Cloud and Cloud Health. In some examples, the cloud account manager 101 uses a security protocol template (e.g., a Guardrails template) for cloud account onboarding and event monitoring. In such examples, the cloud account manager 101 uses the security protocol template to onboard and off-board cloud accounts with required resources. In such examples, the cloud account manager 101 uses the security protocol template to continuously enforce a target configuration state as determined by the security protocol template.

The example network interface 202 of the example cloud account manager 101 is to connect with the example enforcement service 112 (FIG. 1) and the example cloud-based services 102 (FIG. 1). In some examples, the network interface 202 is to communicate data to clouds by transmitting API calls to secure clouds (e.g., the secure cloud 302 of FIG. 3) and receiving API calls from public clouds (e.g., the first public cloud 304A of FIG. 3 and the second public cloud 304B of FIG. 3). In some examples, the network interface 202 is to use the plug-in manager 212 to use protocols that are to operate with the corresponding clouds. In some examples, the network interface 202 is to receive a target configuration state from a user account. In other examples, the network interface 202 is to receive the target configuration state from the enforcement service 112 (FIG. 1). As used herein, a target configuration state is defined using an IDEM structured layer state (SLS) file that includes a template and parameter. In some examples, the target configuration state is referred to as a “desired state” or “desired configuration state.” In some examples, the network interface 202 is to retrieve enforcement policies from the enforcement service 112 (FIG. 1). In some examples, the network interface 202 retrieves the enforcement policies from a user account.

The example drift monitor 204 detects drift between the target configuration state (e.g., a blueprint configuration state, a desired configuration state, a reference configuration state, etc.) of the cloud account and an in-use configuration state of the cloud account (e.g., real-world configuration state, actual configuration state, in-use configuration state, etc.). The example drift monitor 204 compares the in-use configuration state of the cloud account to the target configuration state to detect drift (e.g., deviations between the in-use configuration state and the target configuration state). After the example drift monitor 204 detects a deviation from the target configuration state, the drift monitor 204 is to log a first event record representing the first drift. In some examples, the drift monitor 204 is to monitor and correct the configuration state of the cloud account. In some examples, the drift monitor 204 is to monitor and correct the drift of the cloud account. In some examples, the drift monitor 204 is to monitor and correct the drift of the in-use configuration state of the cloud account relative to the target configuration state of the cloud account.

The example drift monitor 204 stores drift occurrences as a time series. For example, the drift monitor 204 logs the first event record with a corresponding timestamp to represent a first drift at a first time. If there is a subsequent deviation between the in-use configuration state of the cloud account and the target configuration state at a second time, the example drift monitor 204 logs a second event record with a corresponding timestamp to represent the second drift at the second time. In this manner, the example drift monitor 204 generates a timeline of drift data points including the first drift at the first time and the second drift at the second time.

As used herein, drift refers to differences (e.g., deviations) between a target configuration state (e.g., the desired configuration state, the reference configuration state) of a cloud account and an in-use configuration state (e.g., real-world configuration state, in-use configuration state, actual configuration state) of the cloud account. In some examples, the differences may correspond to cloud infrastructure resources associated with the cloud account (e.g., a number of processors in a first virtual compute unit, a memory storage size of a first cluster of virtual compute units, etc.).

In some examples, differences between target and in-use configuration states may correspond to the set-up (e.g., configuration) of the cloud account. Some of these example configuration differences include a change in cloud account role, a change in the cloud account subscription, a change in the cloud account project, a change in a cloud account resources tag, and/or a change in a cloud account environment setting. However, this list is non-exhaustive, and the example drift monitor 204 may log other differences between an in-use configuration state and the target configuration state.

An example of drift may involve a change in cloud account role such as a change in a user privilege level. For example, a cloud account may be onboarded for an employee at a company. The example role associated with the employee's cloud account may be “employee.” If a manager of the employee submits a change request to update the employee cloud account to have a role of “manager,” the example drift monitor 204 compares the cloud account role in the target configuration state (e.g., an “employee” role) and the cloud account role of the in-use employee account (e.g., a “manager” role) and detect that a drift has occurred.

Another example of drift relates to a change in a cloud account subscription. An example cloud account subscription corresponds to a particular cloud services provider which allows provisioning of cloud infrastructure resources to occur. For example, if a cloud account is subscribed to a first cloud services provider (e.g., Amazon Web Services®, (AWS)), the cloud account is to access cloud infrastructure resources from the first cloud services provider (e.g., AWS). If the cloud account subscription is changed to a second cloud services provider (e.g., Microsoft Azure®, Google Cloud Platform™ (GCP) etc.), then the cloud account is directed to access cloud infrastructure resources from the second cloud services provider. The example drift monitor 204 compares the cloud account subscription at the first time (e.g., AWS) and the cloud account subscription at the second time (e.g., GCP) and detects that drift has occurred.

Another example of drift relates to project assignments. In such an example, a company can assign a cloud account and its cloud infrastructure resources to a particular project and assign users access to the cloud infrastructure resources according to the project. For example, a first project may include three employee user accounts and a group of cloud infrastructure resources of a cloud account. If the cloud account is changed to a second project, the example drift monitor 204 compares the projects and determines that drift has occurred.

Another example of drift relates to cloud account resources tags. In such an example, a cloud account resources tag may refer to a label that is applied to objects in a cloud infrastructure resources inventory. For example, a manager may assign a tag to a workload domain, a compute cluster, or a host. If the cloud account resources tag indicates a first workload domain is for use by the cloud account, and the cloud account resources tag is changed to indicate the first workload domain is for use by a second cloud account, the example drift monitor 204 detects that drift in tags have occurred.

Another example of drift relates to cloud account environment. In such an example, cloud account environment details may refer to a resource usage status, a health status, or a warning status for cloud infrastructure resources. For example, if a resource usage capacity of a provisioned cluster is close to full, the cluster may begin to malfunction. The environmental details include these warnings to indicate that the health of the cluster is waning. As the environmental details change, the example drift monitor 204 detects a drift as there is a deviation between a healthy cluster that is using only ten percent capacity and a failing cluster is using ninety percent capacity.

The example in-use policy enforcement controller 206 is to enforce a configured state of a cloud account whenever there is a deviation from a target state. For example, the in-use policy enforcement controller 206, after detection of drift by the example drift monitor 204, changes a configuration of the cloud account based on the target state configuration information. The example in-use policy enforcement controller 206 is to enforce the return back to the target state after the account is onboarded, by monitoring the drift. For example, if a privileged user (e.g., a cloud operations administrator) deletes some cloud infrastructure resources that are to be used in the account onboarding process, the in-use policy enforcement controller 206 re-creates the cloud infrastructure resources for the account onboarding process.

For example, if API keys (e.g., security keys to access an API) are rotated after a period of time (e.g., ninety days, one month, etc.), the in-use policy enforcement controller 206 updates the rotated API key. For example, after the target state configuration information is updated with a new API key after a period of sixty days, the in-use configuration state of the cloud account no longer matches the target configuration state. In this example, the in-use configuration state of the cloud account with the old API key has deviated from the newly updated target configuration state. The example drift monitor 204 logs this drift as a difference in API keys. The example in-use policy enforcement controller 206 then updates the in-use configuration state of the cloud account to match (e.g., correspond to) the target configuration state. There is no impact on users and consumers of the cloud service, as the in-use policy enforcement controller 206 updates the API keys in the background without disruption. The continuous enforcement as provided by the example in-use policy enforcement controller 206 is a second layer of protection for the cloud account. The example onboarding policy enforcement controller 210 provides a first layer of protection for the cloud account.

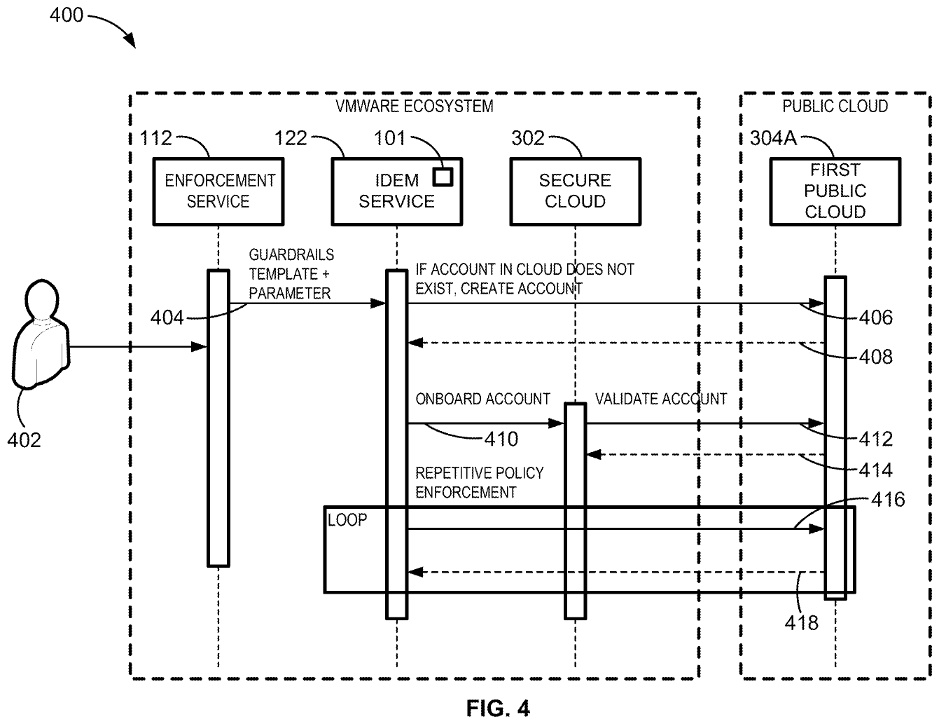

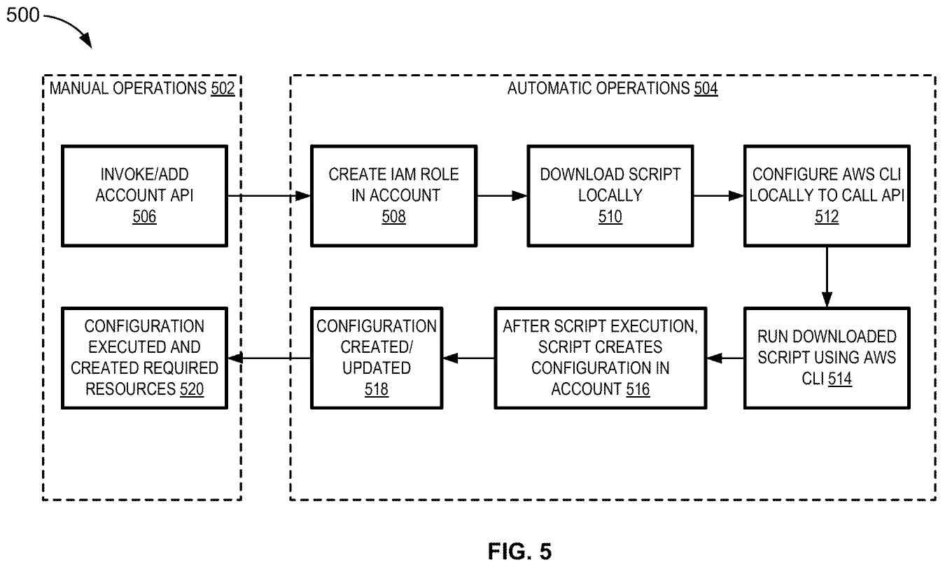

The example cloud account generator 208 is to generate cloud accounts. For example, the cloud account generator 208 may create a cloud account at a public cloud 304 (FIGS. 3 and 4). In such examples, the public cloud 304 hosts the cloud account. After the cloud account is created, at the public cloud 304 (FIGS. 3 and 4), the example cloud account generator 208 may onboard the cloud resources for the cloud account at a secure cloud 302 (FIGS. 3 and 4). As discussed below in connection with FIG. 5, the example cloud account generator 208 is to onboard the cloud account by performing the automatic operations 504 (FIG. 5). The onboarding process configures cloud resources based on the target state configuration information. For example, the target state configuration information may specify that the cloud account has access to three computer processors and sixteen gigabytes of memory.

The example onboarding policy enforcement controller 210 is to enforce policies during an onboarding process of a cloud account. For example, if there is a policy to prevent a user account from updating or deleting the cloud account during the onboarding process, the onboarding policy enforcement controller 210 prevents (e.g., restricts) a user of the user account from updating the cloud account and the resources associated with the cloud account while the cloud account is being onboarded by the example cloud account generator 208. The example onboarding policy enforcement controller 210 provides a first layer of protection for the cloud account by protecting the cloud account during onboarding. The example in-use policy enforcement controller 206 provides a second layer of protection for the cloud account by protecting the cloud account after the cloud account is onboarded by reverting any changes made to the cloud account which deviate from the target state configuration information. In other examples, other policies may be enforced by the onboarding policy enforcement controller 210 to achieve a required governance level. However, a privileged user account may change the target state configuration information.

The example plug-in manager 212 is to retrieve, download, install, use, and/or access plug-ins for the various cloud-based services 102 (FIG. 1). For example, the plug-ins allow communication between the cloud account manager 101 and a secure cloud 302 (FIGS. 3 and 4) and public clouds 304 (FIGS. 3 and 4). After the plug-ins are available for use (e.g., such as the secure cloud plug-in 306 (FIG. 3), the first public cloud plug-in 308 (FIG. 3), and the second public cloud plug-in 310 (FIG. 3)), the example runtime engine 214 executes the plug-ins to access the cloud-based services 102. The example plug-in manager 212 is to validate an onboarded account by transmitting a validation instruction to the secure cloud 302 which transmits the validation to the public cloud (e.g., such as the first public cloud 304A).

The example runtime engine 214 is to execute the plug-ins to connect with the secure cloud 302 or the public clouds 304. As described below in connection with FIG. 3, the example secure cloud plug-in 306, the example first public cloud plug-in 308, and the example second public cloud plug-in 310 are available for execution by the runtime engine 214. The example network interface 202 uses the runtime engine 214 to perform API calls 312 (FIG. 3) on the secure cloud 302 and receive API responses 314 (FIG. 3) from the public clouds 304. The example API calls 312 are used to retrieve, create, and/or update Resource API privileges. The example API responses 314 refer to receiving the Resource API privilege objects.

The example target state configuration information database 216 is to store target state configuration information. For example, the target state configuration information may refer to a number of processing cores, a memory size, and/or other cloud infrastructure resources. In some examples, a target configuration state may be referred to as a desired configuration state. If a user account is able to change the in-use configuration state of the cloud account, without changing the target state configuration information, the in-use policy enforcement controller 206 will revert the cloud account to correspond to the target state configuration information. A user account with privileged access may change target state configuration information of a cloud account, and an in-use configuration state of the cloud account is subsequently updated to match the newly updated target state configuration information. This allows an in-use configuration of a cloud account to remain up to date relative to its corresponding target state configuration information.

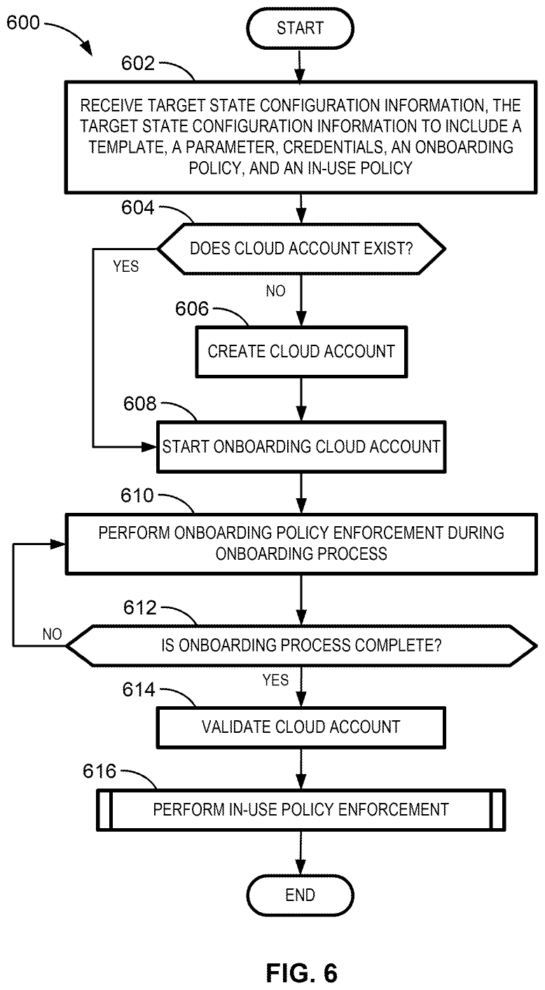

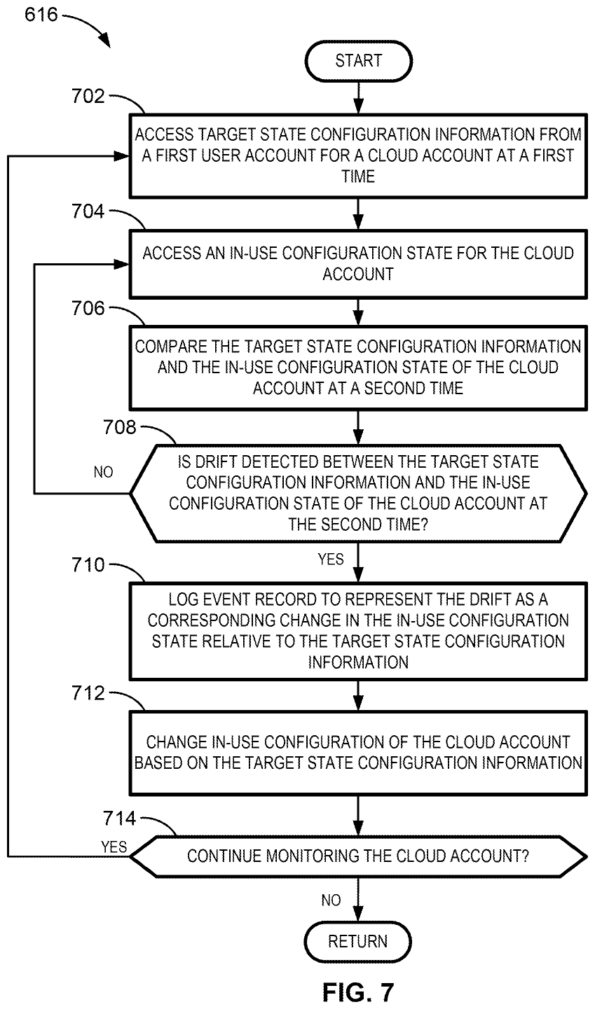

In some examples, the network interface 202 is instantiated by programmable circuitry executing network interface instructions and/or configured to perform operations such as those represented by the flowcharts of FIGS. 6-7.

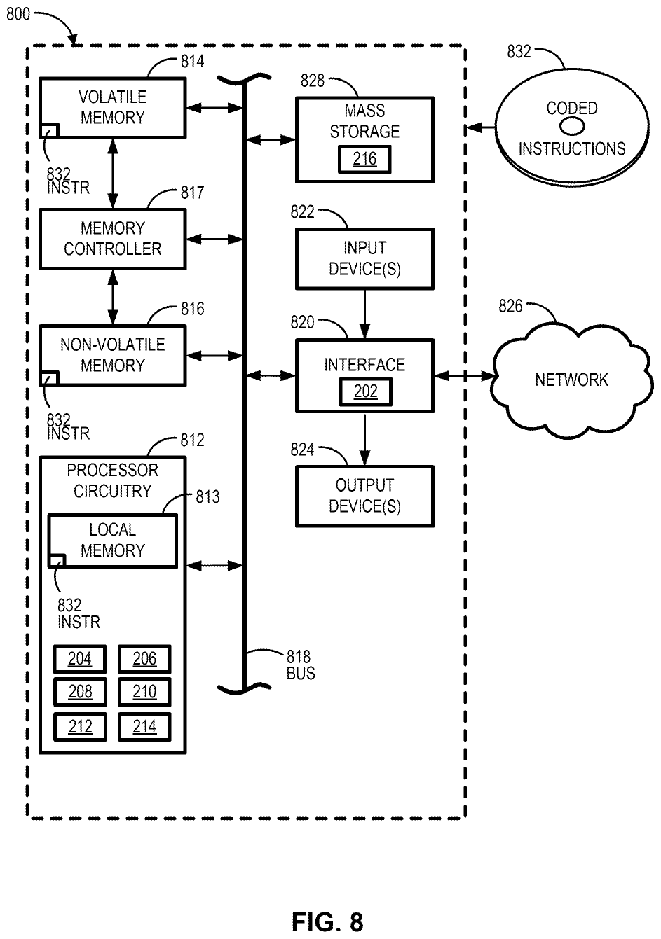

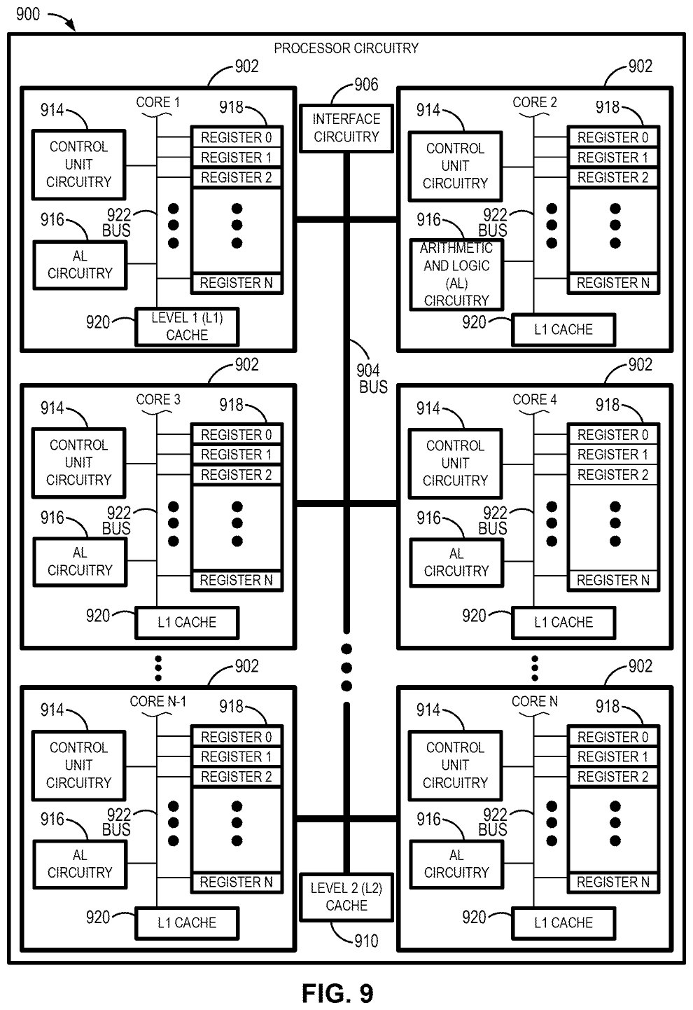

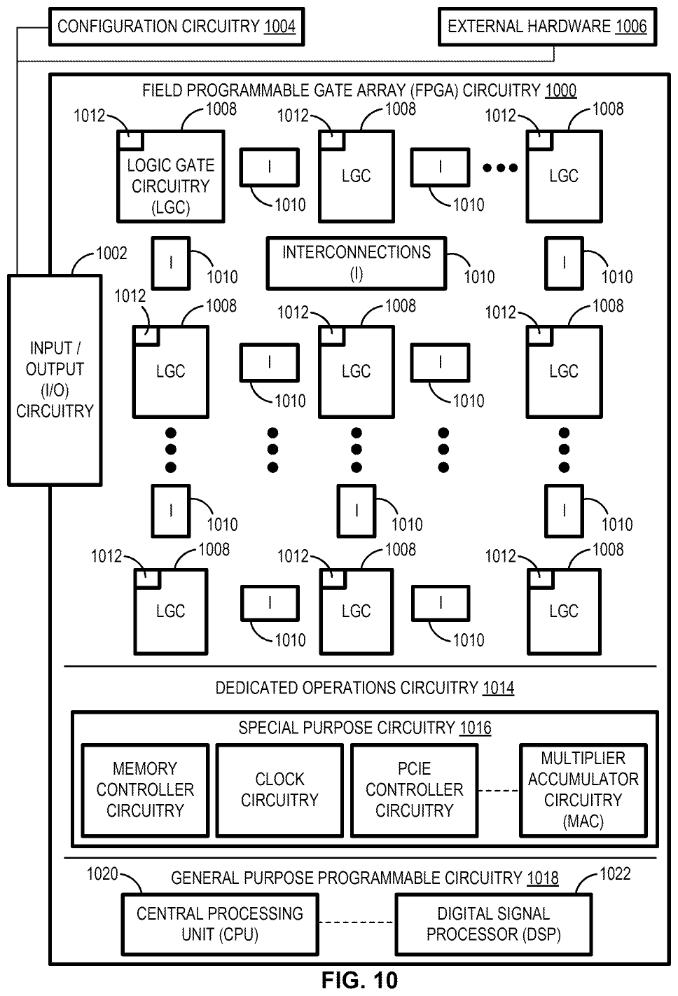

In some examples, the cloud account manager 101 includes means for communicating data. For example, the means for communicating data may be implemented by network interface circuitry such as the network interface 202. In some examples, the network interface 202 may be instantiated by programmable circuitry such as the example programmable circuitry 812 of FIG. 8. For instance, the network interface 202 may be instantiated by the example microprocessor 900 of FIG. 9 executing machine executable instructions such as those implemented by at least blocks 602 of FIGS. 6 and 702 of FIG. 7. In some examples, the network interface 202 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the network interface 202 may be instantiated by any other combination of hardware, software, and/or firmware. For example, the network interface 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the drift monitor 204 is instantiated by programmable circuitry executing network interface instructions and/or configured to perform operations such as those represented by the flowcharts of FIGS. 6-7.

In some examples, the cloud account manager 101 includes means for detecting drift. For example, the means for detecting drift may be implemented by drift monitor circuitry such as the drift monitor 204. In some examples, the drift monitor 204 may be instantiated by programmable circuitry such as the example programmable circuitry 812 of FIG. 8. For instance, the drift monitor 204 may be instantiated by the example microprocessor 900 of FIG. 9 executing machine executable instructions such as those implemented by at least blocks 704 and 706 of FIG. 7. In some examples, the drift monitor 204 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the drift monitor 204 may be instantiated by any other combination of hardware, software, and/or firmware. For example, the drift monitor 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the in-use policy enforcement controller 206 is instantiated by programmable circuitry executing network interface instructions and/or configured to perform operations such as those represented by the flowcharts of FIGS. 6-7.

In some examples, the cloud account manager 101 includes means for changing a configuration of a cloud account. For example, the means for changing a configuration of the cloud account may be implemented by enforcement controller circuitry such as the in-use policy enforcement controller 206. In some examples, the in-use policy enforcement controller 206 may be instantiated by programmable circuitry such as the example programmable circuitry 812 of FIG. 8. For instance, the in-use policy enforcement controller 206 may be instantiated by the example microprocessor 900 of FIG. 9 executing machine executable instructions such as those implemented by at least blocks 616 of FIGS. 6 and 708 of FIG. 7. In some examples, the in-use policy enforcement controller 206 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the in-use policy enforcement controller 206 may be instantiated by any other combination of hardware, software, and/or firmware. For example, the in-use policy enforcement controller 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cloud account generator 208 is instantiated by programmable circuitry executing network interface instructions and/or configured to perform operations such as those represented by the flowcharts of FIGS. 6-7.

In some examples, the cloud account manager 101 includes means for generating a cloud account. For example, the means for generating a cloud account may be implemented by cloud account generator circuitry such as the cloud account generator 208. In some examples, the cloud account generator 208 may be instantiated by programmable circuitry such as the example programmable circuitry 812 of FIG. 8. For instance, the cloud account generator 208 may be instantiated by the example microprocessor 900 of FIG. 9 executing machine executable instructions such as those implemented by at least blocks 604, 606, 608, 610 of FIG. 6. In some examples, the cloud account generator 208 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the cloud account generator 208 may be instantiated by any other combination of hardware, software, and/or firmware. For example, the cloud account generator 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the onboarding policy enforcement controller 210 is instantiated by programmable circuitry executing network interface instructions and/or configured to perform operations such as those represented by the flowcharts of FIGS. 6-7.

In some examples, the cloud account manager 101 includes means for performing an enforcement policy. For example, the means for performing an enforcement policy may be implemented by policy enforcement controller circuitry such as the onboarding policy enforcement controller 210. In some examples, the onboarding policy enforcement controller 210 may be instantiated by programmable circuitry such as the example programmable circuitry 812 of FIG. 8. For instance, the onboarding policy enforcement controller 210 may be instantiated by the example microprocessor 900 of FIG. 9 executing machine executable instructions such as those implemented by at least block 612 of FIG. 6. In some examples, onboarding policy enforcement controller 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the onboarding policy enforcement controller 210 may be instantiated by any other combination of hardware, software, and/or firmware. For example, the onboarding policy enforcement controller 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the plug-in manager 212 is instantiated by programmable circuitry executing network interface instructions and/or configured to perform operations such as those represented by the flowcharts of FIGS. 6-7.

In some examples, the cloud account manager 101 includes means for using plug-ins to access cloud platforms. For example, the means for using plug-ins to access cloud platforms may be implemented by plug-in manager circuitry such as the plug-in manager 212. In some examples, the plug-in manager 212 may be instantiated by programmable circuitry such as the example programmable circuitry 812 of FIG. 8. For instance, the plug-in manager 212 may be instantiated by the example microprocessor 900 of FIG. 9 executing machine executable instructions such as those implemented by at least block 614 of FIG. 6. In some examples, plug-in manager 212 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the plug-in manager 212 may be instantiated by any other combination of hardware, software, and/or firmware. For example, the plug-in manager 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the runtime engine 214 is instantiated by programmable circuitry executing network interface instructions and/or configured to perform operations such as those represented by the flowcharts of FIG. 6.

In some examples, the cloud account manager 101 includes means for executing plug-ins to access cloud resources. For example, the means for executing plug-ins may be implemented by runtime engine circuitry such as the runtime engine 214. In some examples, the runtime engine 214 may be instantiated by programmable circuitry such as the example programmable circuitry 812 of FIG. 8. For instance, the runtime engine 214 may be instantiated by the example microprocessor 900 of FIG. 9 executing machine executable instructions such as those implemented by at least blocks 612 of FIG. 6. In some examples, runtime engine 214 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the runtime engine 214 may be instantiated by any other combination of hardware, software, and/or firmware. For example, the runtime engine 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the cloud account manager 101 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface 202, the example drift monitor 204, the example in-use policy enforcement controller 206, the example cloud account generator 208, the example onboarding policy enforcement controller 210, the example plug-in manager 212, the example runtime engine 214, and/or, more generally, the example cloud account manager 101 of FIG. 2, may be implemented by hardware alone or by hardware in combination with software and/or firmware. Thus, for example, any of the example network interface 202, the example drift monitor 204, the example in-use policy enforcement controller 206, the example cloud account generator 208, the example onboarding policy enforcement controller 210, the example plug-in manager 212, the example runtime engine 214, and/or, more generally, the example cloud account manager 101, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example cloud account manager 101 of FIG. 2 may include one or more elements, processes, and/or devices in addition to, or instead of, those illustrated in FIG. 2, and/or may include more than one of any or all of the illustrated elements, processes and devices.

FIG. 3 is an architectural flow diagram 300 of the example enforcement service 112, the example IDEM service 122, and the example cloud-based services 102. The example cloud-based services 102 include an example secure cloud 302, and a plurality of public clouds 304 (e.g., a first public cloud 304A and a second public cloud 304B). The example IDEM service 122 includes the example cloud account manager 101. The example cloud account manager 101 includes the example runtime engine 214 (as described in connection with FIG. 2). In some examples, the runtime engine 214 is a component of the IDEM service 122 and therefore is an IDEM runtime engine. The example runtime engine 214 includes plug-ins which are managed by the example plug-in manager 212 (FIG. 2). The example plug-ins illustrated in the example of FIG. 3 include an example secure cloud plug-in 306, an example first public cloud plug-in 308, and an example second public cloud plug-in 310. In other examples, the plug-in manager 212 is to download and install other cloud plug-ins for use by the example runtime engine 214.

In the example of FIG. 3, the enforcement service 112 (e.g., VMware Aria® Guardrails™M service) performs (e.g., runs, executes, etc.) an IDEM validate instruction with default values. The example enforcement service 112 performs the IDEM validate instruction by validating the content of an IDEM task submission. The example enforcement service 112 may perform the IDEM validate instruction by validating mandatory input parameters with a valid type. In some examples, for each mandatory input parameter, the IDEM validate instruction includes a range of acceptable parameter values. The example enforcement service 112 provides a template file to the example cloud account manager 101 of the example IDEM service 122. In some examples, the template file is an IDEM structured layer state (SLS) file. The example template file includes parameters for the cloud resources to provision and credentials to access the public clouds 304.

After the IDEM service 122 receives the template file, the example IDEM service 122 uses the example cloud account manager 101 to perform a first set of application programming interface (API) calls 312. The example cloud account manager 101 performs the first set of API calls 312 by using the example secure cloud plug-in 306 to communicate with the example secure cloud 302. The first set of API calls 312 include a create resource instruction, an update resource instruction, and an enforce policies instruction. The example secure cloud 302 receives the first set of instructions. The example cloud account manager 101 receives the API responses 314 from the public clouds 304 (e.g., the first public cloud 304A and the second public cloud 304B). The example API responses 314 (e.g., second set of API calls) include resource objects that were requested in the first set of API calls 312 to the example secure cloud 302. In some examples, the API responses 314 include the policy assignment state.

In some examples, the cloud account manager 101 is to use the network interface 202, rather than using the plug-ins 306, 308, 310, to communicate with the example secure cloud 302 and the first public cloud 304A and the second public cloud 304B.

FIG. 4 is an example sequence diagram 400. In the example of FIG. 4, a developer 402 (e.g., a user, a human being, etc.) is to write software code which is provided to the example enforcement service 112. At event 404, the example enforcement service 112 is to send the template file (e.g., the SLS and the parameter) to the example IDEM service 122. At event 406, the example IDEM service 122 is to use the example cloud account manager 101 to determine if a cloud account exists. In response to determining that a cloud account does not exist, the cloud account manager 101 creates the cloud account at event 406 by accessing the first public cloud 304A. The first public cloud 304A returns the created cloud account to the IDEM service 122 at event 408.

At event 410, the example cloud account generator 208 onboards the cloud account at the example secure cloud 302. The example plug-in manager 212 (FIG. 2) validates the cloud account by transmitting validate account instruction to the secure cloud 302 at event 412, where the secure cloud 302 validates the cloud account at the first public cloud 304A. The example secure cloud 302 may validate the cloud account at the first public cloud 304A (e.g., public cloud vendor) by determining if the cloud account exists (e.g., is valid, is present, is available, etc.) at the first public cloud 304A and by determining if authorization to access the cloud account at the first public cloud 304A has been granted by the example IDEM service 122. At event 414, the example secure cloud 302 receives a response from the example first public cloud 304A. At event 416, the example in-use policy enforcement controller 206 (FIG. 2) performs the policy enforcement at the first public cloud 304A. At event 418, the first public cloud 304A returns the in-use configuration state of the cloud account to the IDEM service 122, and the example drift monitor 204 (FIG. 2) of the IDEM service 122 determines if any deviations between a target configuration state and the in-use configuration state of the cloud account exist. If the example drift monitor 204 determines that deviations exist, the in-use policy enforcement controller 206 updates the cloud account at the first public cloud 304A to align with the target state configuration information. In example FIG. 4, events 416 and 418 can be repeated in a looping fashion until an instruction, interrupt, timeout, etc. ends the loop.

FIG. 5 is an example illustration 500 of a plurality of manual operations 502 (e.g., manual instructions) and a plurality of automatic operations 504 (e.g., automatic instructions). Examples disclosed herein may be used to substantially reduce or eliminate the need for users to perform numerous manual operations when adding a new user or update an existing account corresponding to a user. For example, techniques disclosed herein substantially reduce or eliminate the need to manually activate event monitoring, create management policy for each user, update policy for the roles of the users, perform frequent policy changes for each user that has been onboarded, off-board certain user accounts, delete a user account, and remove related resources that were created through the configuration after the off-boarding.

FIG. 5 illustrates how the cloud account manager 101 automatically perform operations 508, 510, 512, 514, 516, and 518. In FIG. 5, a network interface (e.g., the network interface 202 of FIG. 2) receives user input to perform a first operation 506 which includes invoking (e.g., adding) a cloud account API. In some examples, the network interface 202 performs the first operation 506 by invoking a cloud account API. A second operation 508 is performed by the example cloud account generator 208 (FIG. 2) of the cloud account manager 101. The example cloud account generator 208 performs the second operation 508 by creating an Identity and Access Management (IAM) role with a required trust relationship. The example cloud account generator 208 performs a third operation 510 by downloading a script locally. The example cloud account generator 208 performs a fourth operation 512 by configuring an Amazon Web Services (AWS) command line interface (CLI) locally to call an application programming interface (API). The example cloud account generator 208 performs a fifth operation 514 by running the downloaded script by using the Amazon Web Services command line interface (AWS CLI). The example cloud account generator 208 performs a sixth operation 516, by allowing the script, after the script has been executed, to create the configuration in the cloud account. The example cloud account generator 208 performs a seventh operation 518 of allowing a configuration file to be created and/or updated. In some examples, the cloud account generator 208 uses an infrastructure-as-code (IaC) service to create the configuration file. The IaC service creates the configuration file by using an IDEM SLS file. The example runtime engine 214 creates an execution environment where the example second operation 508, the example third operation 510, the example fourth operation 512, the example fifth operation 514, the example sixth operation 516, and the example seventh operation 518 are executed. User input received at a network interface (e.g., the network interface 202 of FIG. 2) causes the runtime engine 214 to execute the configuration which creates the required resources at operation 520. For example, operation 520 is the output of the operations 508, 510, 512, 514, 516, 518.

The example cloud account manager 101 improves the user (e.g., customer) experience by providing a confidence that errors are prevented during account onboarding processes. In addition, the example cloud account manager 101 allows a user account to see (e.g., determine, visualize, etc.) the drift between an in-use configuration state of a cloud account and a target configuration state of target state configuration information. In addition, the example cloud account manager 101 supports integration capabilities, based on the example secure cloud plug-in 306 (FIG. 3) to the secure cloud 302 (FIG. 3) (e.g., VMware Cloud Health and Secure Cloud). The example cloud account manager 101 supports on-boarding and off-boarding with third-party products (e.g., JIRA and JENKINS).

Flowcharts representative of example machine readable instructions, which may be executed by programmable circuitry to implement and/or instantiate the cloud account manager 101 of FIG. 2 and/or representative of example operations which may be performed by programmable circuitry to implement and/or instantiate the cloud account manager 101 of FIG. 2, are shown in FIGS. 6-7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entirety (ies) of the program(s) and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 6-7, many other methods of implementing the example cloud account manager 101 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 6-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed, instantiated, and/or performed by programmable circuitry to onboard a cloud account. The example machine-readable instructions and/or the example operations 600 of FIG. 6 begin at block 602, at which the network interface 202 (FIG. 2) receives target state configuration information. In some examples, the target state configuration information includes a template, a parameter, credentials, an onboarding policy, and an in-use policy. For example, the network interface 202 may receive a template, a parameter, credentials, an onboarding policy (e.g., a first policy to be enforced upon deployment of a resource), and an in-use policy (e.g., a second policy different from the first policy and to be enforced during use of a resource) from the example enforcement service 112 (FIGS. 1, 3, 4). In some examples, a template is provided by the enforcement service 112 in a template file (e.g., a Guardrails™ template file) that may be implemented as an IDEM structured layer state (SLS) file such as an SLS file in the IDEM language. In some examples, a parameter specifies that an access is for a specific cloud platform. In some examples, credentials provided by the enforcement service 112 are used by the network interface 202 to unlock cloud platforms. For example, the network interface 202 may provide the credentials for use by the plug-ins (e.g., the secure cloud plug-in 306, the first public cloud plug-in 308, and the second public cloud plug-in 310 of FIG. 3), so that the plug-ins may access cloud accounts. The example in-use policy enforcement controller 206 is to enforce the in-use policy. The example onboarding policy enforcement controller 210 is to enforce the onboarding policy.

At block 604, the example cloud account generator 208 (FIG. 2) determines if a cloud account exists. In some examples, the cloud account generator 208 is to determine if a cloud account exists by querying one of the public clouds 304 (FIGS. 3 and 4) to determine if a cloud account exists for the credentials received at block 602. When the example cloud account generator 208 determines that a cloud account exists (block 604: YES), control advances to block 608. Alternatively, in response to the cloud account generator 208 determining that a cloud account does not exist (block 604: NO), control advances to block 606.

At block 606, the example cloud account generator 208 creates a cloud account. For example, the cloud account generator 208 creates the cloud account at one of the public clouds 304 (FIGS. 3 and 4) based on the credentials received at block 602.

At block 608, the example cloud account generator 208 starts onboarding the cloud account. For example, the cloud account generator 208 starts the onboarding process for the cloud account by performing the automatic operations 504 of FIG. 5 to onboard the cloud account at the secure cloud 302 (FIG. 3). The example automatic operations 504 of FIG. 5 include operation 508 (“Creating IAM role in account”), operation 510 (“Download script locally”), operation 512 (“Configure AWS CLI locally to call API”), operation 514 (“Run downloaded script using AWS CLI”), operation 516 (“After script execution, the script creates a CFN in the cloud account”), and operation 518 (“Configuration created”).

While the cloud account is being onboarded (e.g., before the “Yes” of block 612), at block 610 the onboarding policy enforcement controller 210 (FIG. 2) performs (e.g., enforces) the onboarding policy during an onboarding policy enforcement phase. For example, the onboarding policy enforcement controller 210 may enforce the onboarding policy restricts, prevents, or blocks user authorization to update or delete the cloud account. The example onboarding policy may also prevent user authorization to update or delete cloud resources that are created during account onboarding. The onboarding policy enforcement controller 210 which enforces the policy, protects the cloud account by achieving a required governance level. As used herein, a governance level is a set of policies (e.g., protocols) that apply rules to govern cloud infrastructure resources. For example, the example onboarding policy enforcement controller 210 applies policies to manage access, cost, security, consumption, and approvals for cloud infrastructure resources to achieve a target amount (e.g., a target level) of governance. For example, the cloud account is shielded. The example onboarding policy enforcement controller 210 is to enforce the onboarding policy for the duration of the onboarding process.

At block 612, the example cloud account generator 208 determines if the onboarding process is complete and the cloud account is onboarded. The example cloud account generator 208 may determine the cloud account is onboarded by determining that the cloud resources are ready to be accessed by a user. The example cloud account generator 208 may determine the cloud account is onboarded by querying the one of the public clouds 304 corresponding to the cloud account. The example cloud account generator 208 queries the one of the public clouds 304 to confirm whether resources allocated to the cloud account are provisioned and ready to be accessed. In such examples, if the cloud account generator 208 receives a confirmation response from the one of the public clouds 304 indicating that the resources allocated to the cloud account are provisioned and ready to be accessed, the cloud account generator 208 determines the cloud account is onboarded. In response to the example cloud account generator 208 determining that the onboarding process is completed (block 612: YES), control advances to block 614. Alternatively, in response to the example cloud account generator 208 determining that the onboarding process is not completed (e.g., block 612: NO), control returns to block 610.

At block 614, the example plug-in manager 212 validates the cloud account. For example, the plug-in manager 212 may validate the cloud account by using the API to verify if the cloud account exists by using an identifier for the cloud account (accountId) and a cloud provider type (e.g., Google Cloud Platform, Microsoft Azure, etc.).

At block 616, the example in-use policy enforcement controller 206 (FIG. 2) performs (e.g., enforces) an in-use policy during a second policy enforcement phase. For example, the in-use policy enforcement controller 206 may enforce the in-use policy by continuously monitoring an in-use configuration state of a cloud account and enforcing a target configuration state on the cloud account based on whether the in-use configuration state of the cloud account has drifted form the target configuration state. Example operations and/or instructions that may be used to implement block 616 are described below in connection with FIG. 7. The operations and/or instructions 600 of FIG. 6 end.

FIG. 7 is a flowchart representative of example machine readable instructions and/or example operations 616 that may be executed, instantiated, and/or performed by programmable circuitry to continuously enforce an in-use configuration state of a cloud account to match a target configuration state. The example instructions and/or operations 616 may be used to implement blocks 616 of FIG. 6. The example machine-readable instructions and/or the example operations 616 of FIG. 7 begin at block 702, at which the network interface 202 (FIG. 2) accesses target state configuration information from a first user account for a cloud account. For example, the network interface 202 may access the target state configuration information from the target state configuration information database 216 (FIG. 2). In some examples, an authorized user of the first user account may use a computing device to transmit the target state configuration information to the network interface 202. In other examples, the network interface 202 receives the target state configuration information from the enforcement service 112 (FIG. 1).

At block 704, the example drift monitor 204 (FIG. 2) accesses an in-use configuration state for the cloud account. For example, the drift monitor 204 may access an in-use configuration state for the cloud account by determining which cloud infrastructure resources are associated with the cloud account, the target name of the cloud account, the role of the cloud account, the cloud account subscription, the project the cloud account is assigned to, tags associated with the cloud account resources, and a health status of the cloud infrastructure resources associated with the cloud account.

At block 706, the example drift monitor 204 (FIG. 2) compares the target state configuration information and the in-use configuration state of the cloud account at a second time. For example, the drift monitor 204 may compare the target state configuration information and the in-use configuration state of the cloud account to determine if any deviation or drift in the cloud account configuration has occurred.

At block 708, the example drift monitor 204 (FIG. 2) determines if drift is detected between the target state configuration information and the in-use configuration state of the cloud account at a second time. For example, the drift monitor 204 may determine whether drift has occurred based on the comparison of block 706. In some examples, drift may be a change in cloud account role, a change in the cloud account subscription, a change in the cloud account project, a change in a cloud account resources tag, or a change in a cloud account environment setting. In response to determining that drift is detected (block 708: YES), control advances to block 710. Alternatively, in response to determining that drift is not detected (block 708: NO), control returns to block 704.

At block 710, the example drift monitor 204 logs a first event record to represent the first drift and a corresponding change in the in-use configuration state relative to the target state configuration information. For example, the drift monitor 204 may log a first event record to represent the first drift and log a corresponding change in the in-use configuration state of the cloud account relative to the target state configuration information by using a timeline of event records. In some examples, the drift monitor 204 determines that subsequent deviations are to be stored as second drift. In such examples, the drift monitor 204 logs a second event record to represent the second drift in a timeline of event records.

At block 712, the example in-use policy enforcement controller 206 changes the in-use configuration of the cloud account based on the target state information. For example, the in-use policy enforcement controller 206 may change the in-use configuration of the cloud account (e.g., change the in-use configuration state of the cloud account) by resetting the cloud account to match the target state configuration information.

At block 714, the example drift monitor 204 determines whether to continue monitoring the cloud account. For example, in response to the drift monitor 204 determining to continue monitoring the cloud account (block 714: YES), control returns to block 712. Alternatively, in response to the example drift monitor 204 determining to not continue monitoring the cloud account (block 714: NO), the operations and/or instructions 616 of FIG. 7 end.

FIG. 8 is a block diagram of an example programmable circuitry platform 800 structured to execute and/or instantiate the example machine-readable instructions and/or the example operations of FIGS. 6-7 to implement the cloud account manager 101 of FIG. 2. The programmable circuitry platform 800 can be, for example, a server, a personal computer, a workstation, a self-learning machine (e.g., a neural network), an Internet appliance, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example drift monitor 204, the example in-use policy enforcement controller 206, the example cloud account generator 208, the example onboarding policy enforcement controller 210, the example plug-in manager 212, and the example runtime engine 214.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In example FIG. 8, the interface circuitry 820 implements the network interface 202 of FIG. 2.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In example FIG. 8, the target state configuration information database 216 of FIG. 2 is implemented in the one or more mass storage discs or devices 828.

The machine readable instructions 832, which may be implemented by the machine readable instructions of FIGS. 6-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6-7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (Ics) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 6-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 6-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 6-7. As such, the FPGA circuitry 1000 may be configured and/or structured to effectively instantiate some or all of the operations/functions corresponding to the machine readable instructions of the flowcharts of FIGS. 6-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 6-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIG. 6-7, and/or an ASIC may be configured and/or structured to perform third operation(s)/function(s) corresponding to a third portion of the machine readable instructions represented by the flowcharts of FIGS. 6-7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

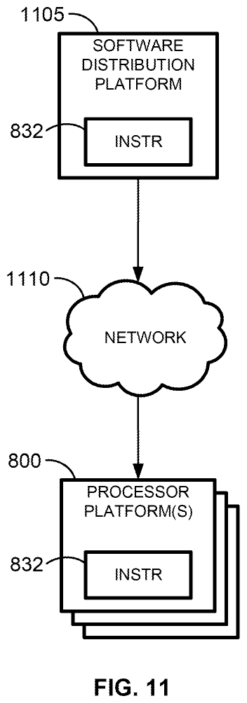

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 6-7, may be downloaded to the example programmable circuitry platform 800, which is to execute the machine readable instructions 832 to implement the cloud account manager 101. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that monitor and correct configuration and configuration drift in cloud accounts. Disclosed systems, apparatus, articles of manufacture, and methods improve the efficiency of using a computing device by changing the configuration of the cloud account to match a target state configuration, which reduces wasted processor cycles. Before the techniques disclosed herein, a user would manually perform multiple API requests to reset the in-use configuration state of the changed cloud account to match the target configuration state. The techniques disclosed herein reduce a network traffic which saves computing processor cycles. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to monitor and correct configuration and configuration drift in cloud accounts are disclosed herein. Further examples and combinations thereof include the following:

Example 1 includes a system comprising network interface circuitry, machine-readable instructions, and programmable circuitry to at least one of instantiate or execute the machine-readable instructions to access target state configuration information from a first user account for a cloud account, complete an onboarding process to onboard the cloud account at a first time, the onboarding process to configure cloud resources based on the target state configuration information, detect a first drift between the target state configuration information and an in-use configuration state of the cloud account at a second time, log a first event record representing the first drift and a corresponding change in the in-use configuration state relative to the target state configuration information, the first event record logged in a timeline of second event records representing second drifts of the cloud account relative to the target state configuration information, and change an in-use configuration of the cloud account based on the first drift and the target state configuration information.

Example 2 includes the system of example 1, wherein the programmable circuitry is to, during the onboarding process and before the onboarding process is completed, enforce an onboarding policy that restricts a user from at least one of updating or deleting the cloud account.

Example 3 includes the system of example 1, wherein the first drift between the target state configuration information and the in-use configuration state of the cloud account at the second time is based on a change request from a user account with a first authorized status.

Example 4 includes the system of example 3, wherein the programmable circuitry is to update the target state configuration information in response to a change request from a user account with a second authorization status, the second authorization status granting more privileges than the first authorization status.

Example 5 includes the system of example 1, wherein the programmable circuitry is to validate the cloud account after the onboarding process is completed.

Example 6 includes the system of example 1, wherein the programmable circuitry is to detect the first drift as a change in at least one of a cloud account role, a cloud account subscription, a cloud account project, a cloud account resources tag, or a cloud account environment setting.

Example 7 includes the system of example 1, wherein the programmable circuitry is to onboard the cloud account by generating an identity and access management (IAM) role for the cloud account, downloading a script, configuring a cloud provider command line interface (CLI) to call an application programming interface (API), executing the downloaded script with the cloud provider CLI, and generating an infrastructure-as-code service for the cloud account.

Example 8 includes the system of example 7, wherein the programmable circuitry is to execute the infrastructure-as-code service to generate the cloud resources.

Example 9 includes the system of example 1, wherein the programmable circuitry is to submit API calls to a secure cloud platform, and retrieve API responses from a public cloud platform, the public cloud platform to host the cloud account.

Example 10 includes the system of example 1, wherein the programmable circuitry is to change the in-use configuration of the cloud account by performing a second onboarding of the cloud account with a second security key after an expiration of a first security key.

Example 11 includes a non-transitory machine readable storage medium comprising instructions to cause programmable circuitry to at least access target state configuration information from a first user account for a cloud account, complete an onboarding process to onboard the cloud account at a first time, the onboarding process to configure cloud resources based on the target state configuration information, detect a first drift between the target state configuration information and an in-use configuration state of the cloud account at a second time, log a first event record representing the first drift and a corresponding change in the in-use configuration state relative to the target state configuration information, the first event record logged in a timeline of second event records representing second drifts of the cloud account relative to the target state configuration information, and change an in-use configuration of the cloud account based on the first drift and the target state configuration information.

Example 12 includes the non-transitory machine readable storage medium of example 11, wherein the instructions are to cause the programmable circuitry to, during the onboarding process and before the onboarding process is completed, enforce an onboarding policy that restricts a user from at least one of updating or deleting the cloud account.

Example 13 includes the non-transitory machine readable storage medium of example 11, wherein the instructions are to cause the programmable circuitry to validate the cloud account after the onboarding process is completed.

Example 14 includes the non-transitory machine readable storage medium of example 11, wherein the instructions are to cause the programmable circuitry to detect the first drift as a change in at least one of a cloud account role, a cloud account subscription, a cloud account project, a cloud account resources tag, or a cloud account environment setting.

Example 15 includes the non-transitory machine readable storage medium of example 11, wherein the instructions are to cause the programmable circuitry to onboard the cloud account by generating an identity and access management (IAM) role for the cloud account, downloading a script, configuring a cloud provider command line interface (CLI) to call an application programming interface (API), executing the downloaded script with the cloud provider CLI, and generating an infrastructure-as-code service for the cloud account.

Example 16 includes the non-transitory machine readable storage medium of example 15, wherein the instructions are to cause the programmable circuitry to execute the infrastructure-as-code service to generate the cloud resources.

Example 17 includes the non-transitory machine readable storage medium of example 11, wherein the instructions are to cause the programmable circuitry to submit API calls to a secure cloud platform, and retrieve API responses from a public cloud platform, the public cloud platform to host the cloud account.

Example 18 includes the non-transitory machine readable storage medium of example 11, wherein the instructions are to cause the programmable circuitry to change the in-use configuration of the cloud account by performing a second onboarding of the cloud account with a second security key after an expiration of a first security key.

Example 19 includes a method comprising accessing target state configuration information from a first user account for a cloud account, onboarding the cloud account at a first time to configure cloud resources based on the target state configuration information, detecting a first drift between the target state configuration information and an in-use configuration state of the cloud account at a second time, logging a first event record representing the first drift and a corresponding change in the in-use configuration state relative to the target state configuration information, the first event record logged in a timeline of second event records representing second drifts of the cloud account relative to the target state configuration information, and changing an in-use configuration of the cloud account based on the first drift and the target state configuration information.

Example 20 includes the method of example 19, further including enforcing an onboarding policy that restricts a user from at least one of updating or deleting the cloud account during the onboarding of the cloud account.

Example 21 includes the method of example 19, further including validating the cloud account after onboarding the cloud account.

Example 22 includes the method of example 19, further including detecting the first drift as a change in at least one of a cloud account role, a cloud account subscription, a cloud account project, a cloud account resources tag, or a cloud account environment setting.

Example 23 includes the method of example 22, further including onboarding the cloud account by generating an identity and access management (IAM) role for the cloud account, downloading a script, configuring a cloud provider command line interface (CLI) to call an application programming interface (API), executing the downloaded script with the cloud provider CLI, and generating an infrastructure-as-code service for the cloud account.

Example 24 includes the method of example 23, further including executing the infrastructure-as-code service, the infrastructure-as-code service to generate the cloud resources.

Example 25 includes the method of example 19, further including performing API calls to a secure cloud platform, and retrieve API responses from a public cloud platform, the public cloud platform to host the cloud account.

Example 26 includes the method of example 19, further including changing the in-use configuration of the cloud account by performing a second onboarding of the cloud account with a second security key after an expiration of a first security key.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
network interface circuitry;
machine-readable instructions; and
programmable circuitry to at least one of instantiate or execute the machine-readable instructions to:
access target state configuration information from a first user account for a cloud account;
complete an onboarding process to onboard the cloud account at a first time, the onboarding process to configure cloud resources based on the target state configuration information;
detect a first drift between the target state configuration information and an in-use configuration state of the cloud account at a second time;
log a first event record representing the first drift and a corresponding change in the in-use configuration state relative to the target state configuration information, the first event record logged in a timeline of second event records representing second drifts of the cloud account relative to the target state configuration information; and
change an in-use configuration of the cloud account based on the first drift and the target state configuration information.

2. The system of claim 1, wherein the programmable circuitry is to, during the onboarding process and before the onboarding process is completed, enforce an onboarding policy that restricts a user from at least one of updating or deleting the cloud account.

3. The system of claim 1, wherein the first drift between the target state configuration information and the in-use configuration state of the cloud account at the second time is based on a change request from a user account with a first authorized status.

4. The system of claim 3, wherein the programmable circuitry is to update the target state configuration information in response to a change request from a user account with a second authorization status, the second authorization status granting more privileges than the first authorization status.

5. The system of claim 1, wherein the programmable circuitry is to validate the cloud account after the onboarding process is completed.

6. The system of claim 1, wherein the programmable circuitry is to detect the first drift as a change in at least one of a cloud account role, a cloud account subscription, a cloud account project, a cloud account resources tag, or a cloud account environment setting.

7. The system of claim 1, wherein the programmable circuitry is to onboard the cloud account by:
generating an identity and access management (IAM) role for the cloud account;
downloading a script;
configuring a cloud provider command line interface (CLI) to call an application programming interface (API);
executing the downloaded script with the cloud provider CLI; and
generating an infrastructure-as-code service for the cloud account.

8. The system of claim 7, wherein the programmable circuitry is to execute the infrastructure-as-code service to generate the cloud resources.

9. The system of claim 1, wherein the programmable circuitry is to submit API calls to a secure cloud platform, and retrieve API responses from a public cloud platform, the public cloud platform to host the cloud account.

10. The system of claim 1, wherein the programmable circuitry is to change the in-use configuration of the cloud account by performing a second onboarding of the cloud account with a second security key after an expiration of a first security key.

11. A non-transitory machine readable storage medium comprising instructions to cause programmable circuitry to at least:
access target state configuration information from a first user account for a cloud account;
complete an onboarding process to onboard the cloud account at a first time, the onboarding process to configure cloud resources based on the target state configuration information;
detect a first drift between the target state configuration information and an in-use configuration state of the cloud account at a second time;
log a first event record representing the first drift and a corresponding change in the in-use configuration state relative to the target state configuration information, the first event record logged in a timeline of second event records representing second drifts of the cloud account relative to the target state configuration information; and
change an in-use configuration of the cloud account based on the first drift and the target state configuration information.

12. The non-transitory machine readable storage medium of claim 11, wherein the instructions are to cause the programmable circuitry to, during the onboarding process and before the onboarding process is completed, enforce an onboarding policy that restricts a user from at least one of updating or deleting the cloud account.

13. The non-transitory machine readable storage medium of claim 11, wherein the instructions are to cause the programmable circuitry to validate the cloud account after the onboarding process is completed.

14. The non-transitory machine readable storage medium of claim 11, wherein the instructions are to cause the programmable circuitry to detect the first drift as a change in at least one of a cloud account role, a cloud account subscription, a cloud account project, a cloud account resources tag, or a cloud account environment setting.

15. The non-transitory machine readable storage medium of claim 11, wherein the instructions are to cause the programmable circuitry to onboard the cloud account by:
generating an identity and access management (IAM) role for the cloud account;
downloading a script;
configuring a cloud provider command line interface (CLI) to call an application programming interface (API);
executing the downloaded script with the cloud provider CLI; and
generating an infrastructure-as-code service for the cloud account.

16. The non-transitory machine readable storage medium of claim 15, wherein the instructions are to cause the programmable circuitry to execute the infrastructure-as-code service to generate the cloud resources.

17. The non-transitory machine readable storage medium of claim 11, wherein the instructions are to cause the programmable circuitry to submit API calls to a secure cloud platform, and retrieve API responses from a public cloud platform, the public cloud platform to host the cloud account.

18. The non-transitory machine readable storage medium of claim 11, wherein the instructions are to cause the programmable circuitry to change the in-use configuration of the cloud account by performing a second onboarding of the cloud account with a second security key after an expiration of a first security key.

19. A method comprising:
accessing target state configuration information from a first user account for a cloud account;
onboarding the cloud account at a first time to configure cloud resources based on the target state configuration information;
detecting a first drift between the target state configuration information and an in-use configuration state of the cloud account at a second time;
logging a first event record representing the first drift and a corresponding change in the in-use configuration state relative to the target state configuration information, the first event record logged in a timeline of second event records representing second drifts of the cloud account relative to the target state configuration information; and
changing an in-use configuration of the cloud account based on the first drift and the target state configuration information.

20. The method of claim 19, further including enforcing an onboarding policy that restricts a user from at least one of updating or deleting the cloud account during the onboarding of the cloud account.

21. The method of claim 19, further including validating the cloud account after onboarding the cloud account.

22. The method of claim 19, further including detecting the first drift as a change in at least one of a cloud account role, a cloud account subscription, a cloud account project, a cloud account resources tag, or a cloud account environment setting.

23. The method of claim 22, further including onboarding the cloud account by:
generating an identity and access management (IAM) role for the cloud account;
downloading a script;
configuring a cloud provider command line interface (CLI) to call an application programming interface (API);
executing the downloaded script with the cloud provider CLI; and
generating an infrastructure-as-code service for the cloud account.

24. The method of claim 23, further including executing the infrastructure-as-code service, the infrastructure-as-code service to generate the cloud resources.

25. The method of claim 19, further including performing API calls to a secure cloud platform, and retrieve API responses from a public cloud platform, the public cloud platform to host the cloud account.

26. The method of claim 19, further including changing the in-use configuration of the cloud account by performing a second onboarding of the cloud account with a second security key after an expiration of a first security key.
